(19) United States
(12) Patent Application Publication
(10) Pub. No.: US 2016/0347114 A1
(43) Pub. Date: Dec. 1, 2016

(54) A MACHINE AND A PROCESS FOR PRODUCING DUPLICATES OF AN OBJECT HAVING A DECORATIVE THREE-DIMENSIONAL SURFACE

(71) Applicant: Leonardo PANETTIERI, Pisa (IT)

(72) Inventor: Leonardo PANETTIERI, Pisa (IT)

(21) Appl. No.: 15/116,870

(22) PCT Filed: Feb. 5, 2015
(86) PCT No.: PCT/IB2015/050872

§ 371 Date: Aug. 5, 2016

(30) Foreign Application Priority Data
Feb. 6, 2014 (IT) PI2014A000010
Nov. 3, 2014 (IT) PI2014A000081

(51) Int. Cl. B44B 1/02; B29C 33/38; B29C 43/02; B41M 5/00; B29C 67/00; B29C 43/50; B33Y 10/00; B33Y 80/00; B44B 1/00; B29C 43/52

(52) U.S. Cl. CPC B44B 1/02; B44B 1/006; B29C 33/3892; B29C 43/021; B29C 43/52; B29C 67/0051; B29C 43/50; B33Y 10/00; B33Y 80/00; B41M 5/0023; B44B 2700/09; B29C 2043/023; B29L 2031/757

(57) ABSTRACT

A process for duplicating in series an object having a decorative three-dimensional surface comprising a plurality of ridges, or protrusions. The process comprises, in particular the steps of introducing the object in a hollow container body having an side containing side that extends, in use, beyond the object. A step follows of distribution on said object of a setting material to cover the decorative three-dimensional surface of the object. Once the setting material sets, a mould is obtained having at the face oriented towards the object a three-dimensional surface that reproduces in negative the object's three-dimensional surface. The process provides then distributing a thermoplastic material on a first face of a support obtaining a layer having a predetermined height. Then, the support and the mould are overlapped to one another to obtain a system consisting of the support and of the mould, where the first face of the support is arranged in contact with the three-dimensional surface of the mould. The layer of the thermoplastic material, thus obtained, is cooled in order to provide a cast that is then subject to a printing step to obtain a duplication of the starting object.

### FIELD OF THE INVENTION

The present invention relates to the field of duplication of artwork, such as paintings, in particular oil paintings, but also pictures, and, in particular it relates to a process for duplicating in series original artwork.

### DESCRIPTION OF THE PRIOR ART

As well known, different methods exist for duplicating in series original artwork, in particular painting or photography artwork.

A process known for duplication of paintings provides taking a picture of the painting and then projecting the picture on canvas or other support.

Then, an operator follows the lines of the projected painting and duplicates it, by drawing corresponding coloured brush strokes.

This process, however, has many drawbacks.

Firstly, the final result of the process is necessarily affected by the “hand” of the operator i.e. to its artistic skill and experience, since the operator determines manually the duplication of the original artwork. Therefore, this type of process in addition to require a long time for being completed, does not allow reproducing in series the original artwork, usually a painting. In fact, notwithstanding the reproductions can be similar to each other, the duplications made with the known techniques have apparent differences, since the brush strokes of the operator are in turn different from each other.

Furthermore, notwithstanding the original duplication is close to the original artwork, it presents in any case, even for a layman, apparent and macroscopic differences with respect to the original artwork. Moreover, since the above described process takes into account exclusively the two-dimensional spatial size (x,y) of the artwork, the aesthetic overall effect, which is, instead, strongly influenced by the thickness of the brush-strokes, is not met, since in the above described process as well as in other similar processes, the thickness is often a parameter that is overlooked. On the other hand, the thickness of colours influences, in particular, the way with which the light is reflected by the surface of the painting and produces, then, a particular aesthetic effect.

An attempt of overcoming this drawback has been made by various processes. For example JP7257099 discloses a process that provides distributing a thermosetting material directly on the original artwork. Then, a step follows of pressing and heating the thermosetting material for causing it to harden appropriately, at the end of which a mould is obtained to reproduce a negative of the surface of the painting artwork. It is provided, moreover, a step of distributing a resin layer in liquid state on a base material. Then, a steps follows in which the mould previously obtained is arranged on the resin layer and pressed against the same up to the hardening the resin. On the hardened resin layer a plastic film is then connected with a predetermined pattern that once adhered to said resin layer reproduce a duplicate of the original artwork.

In said process, as well as in other similar processes, the risk is high of damaging the original artwork due to the application of the thermosetting material on its surface and the pressing thereof.

Another drawback of the prior art methods is a limit of production rate i.e. a very low production rate.

### SUMMARY OF THE INVENTION

It is then a feature of the present invention to provide an improved process to provide duplication of an object having a decorative three-dimensional surface for speeding up the whole process and at the same time to obtain very exact duplication in series of the original.

It is also a feature of the present invention to provide a process to provide a duplication of an object avoiding risks for the original artwork.

It is also a feature of the present invention to provide a process to provide a duplication of an object that is completely automatic and does not need the work of an operator.

These and other features are accomplished with one exemplary process, according to the present invention, to provide a duplication of an object having a decorative three-dimensional surface comprising a plurality of ridges, or protrusions, each ridge of said plurality having a predetermined thickness (s), or height, said method comprising the steps of:
introducing the object in a container body;
distributing on the object of a setting material, said setting material covering the whole decorative three-dimensional surface;
hardening the setting material to obtain a mould, said mould presenting at the face oriented towards the object a three-dimensional surface that reproduces a negative of the three-dimensional decorative surface of the object;
arranging a substantially planar support;
distributing a predetermined amount of a thermoplastic material on a first face of the support obtaining a layer of said thermoplastic material having a predetermined height;
arranging said support and said mould overlapped to one another to obtain a system comprising said support and said mould wherein said first face of said support is arranged in contact with said three-dimensional surface of said mould;
applying heat and pressure to said system in such a way to cause a substantial melting of said thermoplastic material and its distribution on the three-dimensional surface of the mould, obtaining a corresponding layer of said substantially molten thermoplastic material;
cooling said corresponding layer of said thermoplastic material in such a way to cause it to harden obtaining a cast of the object, said cast having a decorative surface that reproduces the three-dimensional surface of the mould and, accordingly, of the starting object, said decorative surface of said cast comprising a plurality of ridges with thicknesses corresponding to the thicknesses of said ridges of said starting object;
printing the decorative surface obtaining a printed decorative surface and, accordingly, a duplication of the object.

Preferably, said printing step is made by a printing apparatus.

In particular the heat and the pressure are applied to the system for causing the diffusion of substantially molten thermoplastic material on the three-dimensional surface, and distributing it uniformly on all the surface 3D of the mould.

In an exemplary embodiment, the step of distributing the thermoplastic material, in particular an adhesive thermo-fusible material, can be made by spraying, or lamination, or by a transfer roller, or using other devices that spread the second material directly on the support. This way, it is possible to provide a more precise distribution of the thermo-fusible material. Furthermore, this solution assists the automatization of the whole process.

In particular at the end of the step of applying the thermoplastic material on the support a layer is obtained of the thermoplastic material having a thickness set between 50 μm and 20 mm.

In particular the object can be a model reproducing an original artwork.

In particular the original artwork has a three-dimensional surface comprising a plurality of ridges, or protrusions, each ridge of said plurality having a predetermined thickness, or height. In this case, a step is provided of making the object, i.e. the model.

For example, the step of making the model can comprise the following steps:
three-dimensional scanning of the original artwork obtaining a three-dimensional virtual image corresponding to the three-dimensional surface of the original artwork, said three-dimensional virtual image comprising a plurality of points, or pixels having determined spatial coordinates (x,y,z);
producing, on the basis of said spatial coordinates (x,y,z), an object, i.e. the model having said surface that reproduces said three-dimensional virtual image, said object, or model, being made of an easily formable material.

Advantageously, the step of making the model can be made by a 3D printing. In an exemplary embodiment of the invention, the model can be obtained by a pantograph.

In particular the object may have shape substantially of a plate.

It is pointed out that by the expression “original artwork” a starting artwork as a painting artwork, or a photographical artwork, or an object of other kind having a surface in relief, or an artwork made intentionally for making duplicates.

In particular the solution provided by the present invention, with respect to presently known solutions of the prior art, provides totally exact duplicates in series of the original object.

This result is obtained, in particular by using directly the original artwork as model, in a first exemplary embodiment of the present process, or by preparing the model, for example by a pantograph, or a 3D printing, which makes it possible to obtain a highly reliable “positive”, or a “negative” of the original artwork, in a further exemplary embodiment of the present process.

In particular the making the model and, accordingly, of ridges having a certain thickness s, and depressions having a predetermined depth, assists the successive step of preparing the “negative”, i.e. the mould. In one case, i.e. when firstly the positive and then the negative are obtained, the above level of precision is reached by the intermediate passage of making the model.

In the another case, i.e. when directly the negative is obtained, the above level of precision is reached since the starting material, stiff, or semirigid, is “engraved” by high precision tools with a negative sign of the coordinate “z” of the points, from +z to −z, which perform depressions where the original artwork has ridges.

With the term “printing” a step of application of colour on the decorative surface is generally considered. This can be obtained by means of different techniques.

In particular the printing step can be made by at least one of the following techniques:
printing, or thermoprinting, with sublimation inks;
inkjet printing;
printing with heat transfer inks;
printing with water based inks;
printing with UV inks, i.e. ultraviolet inks;
offset printing;
printing with solvent based inks;
printing with resin based inks;
laser printing;
dye sublimation printing;
screen printing;
or a combination thereof.

Preferably, the printing apparatus can be a printer, or a plotter, which uses, for printing, one of the above described technologies.

In particular as well known, thermo-printing provides conveying the ink on the surface of the support by the heat generated by a thermal printing head. Offset printing, instead, is a process of planographic printing, and is a printing system that uses a plane matrix typical of phototypesetting and of lithography.

Preferably, the printing is a register printing. In particular by the expression “register printing” it is meant a step of application of colour, in a referred way, on the three-dimensional surface of the cast.

Advantageously, a step is provided of definition on the three-dimensional surface of at least one reference point, preferably of at least two reference points. It is obtained, then a referred positioning between printing machine and the or each reference point and, then, to the three-dimensional surface. This way, there is the certainty of applying a predetermined amount of a specific colour at a specific area of the three-dimensional surface. This can be obtained by means of different techniques.

The method, according to the invention, can provide that the data concerning the three-dimensional shape of the surface of the original artwork detected by the three-dimensional scanning are recorded on a magnetic support, or digital, or sent remotely by a Internet connection. This way, it is possible that the owner and/or directly the author of the artwork same, carry out the three-dimensional scanning without causing the risk that the artwork is stolen, or damaged, during the transportation. The data obtained by the three-dimensional scanning can then be transmitted to whom carries out the further steps provided by the present method for making the duplication of the original artwork.

In particular before the printing step a step can be provided of patination of the decorative surface. More in detail, the patination step, made by means of known techniques, is a work on the decorative surface for optimizing the absorbed amount of colour, or ink. For example, the patination can provide the application of a uniform thin layer, or film, on the decorative surface for improving the surface aspect and preparing it for printing for improving therefore the printing quality.

For example, the patination step can provide applying a thin layer, or film, in particular of resin on said decorative surface for increasing the capacity of ink absorption, in order to optimize the printing quality.

Alternatively, the printing step can be made by a laser printer, or a laser plotter.

In addition to the above described works, after printing a step can be provided of application of a finishing layer on the printed decorative surface so that the surface of each duplication is similar to the original. More in detail, the finishing step can provide the application of a film, or layer, of a resin, or of an oil, on the printed decorative surface, such that the same aesthetic effect of the original is obtained, versus brightness, opacity, etc.

In particular after the step of distributing the setting material in the mould a step is provided of arranging a base sheet on the layer of thermoplastic material, opposite to the mould, said decorative surface being made opposite to said mould.

In this case, before the printing step a step is provided of arranging said sheet, or support, as base with respect to said printing apparatus, in order to cause the thicknesses made on said layer to coincide with those of the image to print, i.e. the image present on said surface of said original artwork, on said decorative surface.

Advantageously, the model is made shaping a semi-finished product of an easily formable material selected from the group consisting of:
a material based on gypsum, in particular a paste, or an aqueous solution, containing gypsum;
a resin, in particular a thermoplastic resin, or a mixture of thermoplastic resins;
or a combination thereof.

In particular the setting material can be selected from the group consisting of:
gypsum, in particular a material based on gypsum;
silicone rubber;
an epoxy resin;
a polyurethane resin;
a thermoplastic resin;
a mixture of thermoplastic resins;
a silicone rubber;
a photopolymer
or a combination thereof.

In a preferred exemplary embodiment the setting material is silicone rubber.

In particular the base sheet, or support, can be made of a material selected from the group consisting of:
wood;
canvas;
non woven fabric;
metal material;
plastic material;
a stiff material;
a flexible material;
paper, or cardboard.

In case the base sheet, or support, is applied, the relative location thereof with respect to printing apparatus to be taken as reference, in order to provide a “register printing”, as described above, for very precise application of the colour on the three-dimensional surface reproducing the three-dimensional surface of the real object, or the virtual object.

Advantageously, said thermoplastic material is selected from the group consisting of:
a thermoplastic resin;
a mixture of thermoplastic resins.

It is also a feature of the present invention to provide a machine for carrying out the method, as described above, for producing duplicates of an object having a decorative three-dimensional surface.

In an exemplary embodiment, the setting material is a metal material, in particular a metal material in the molten state.

Advantageously, before the step of distributing the setting material a step is provided of distribution of a layer of sand on the surface of said object, such that a layer of sand is obtained having a predetermined height on which is then distributed the setting material.

In particular at the end of the heating step it is possible to provide a cooling step of the layer of thermoplastic material, to obtain a predetermined hardening rate thereof.

According to another aspect of the invention, a process for making in series an object having a decorative three-dimensional surface comprising a plurality of ridges, or protrusions, each ridge of said plurality having a predetermined thickness, or height (s), said process comprising the steps of:
making a stiff or semirigid mould having a surface that reproduces in negative said surface of said object;
moulding, by said mould, a surface of a layer of thermoplastic material to obtain a modeled layer, said moulding step providing a pressing and a heating of said layer of thermoplastic material;
extracting said modeled layer of thermoplastic material having a modeled surface that reproduces said surface of said starting object, said modeled surface comprising a plurality of ridges with thicknesses corresponding to those of said ridges of said starting object;
register printing said modeled surface obtaining a corresponding decorative surface and then a duplication of said object.

In particular the step of making the mould provides a cutting step of a body of stiff material, or semirigid, by a cutting device.

Preferably, the cutting step is carried out by the cutting device on the basis of predetermined working data.

Advantageously, the working data are obtained through a construction by a graphical program, in particular a CAD program, of the three-dimensional shape of an object.

In particular at the end of the moulding step a cooling step can be provided for cooling the layer of thermoplastic material up to cause a hardening thereof.

Alternatively, working data can be obtained through a three-dimensional scanning of a real three-dimensional object. More in detail, the scanning provides data acquisition on the shape of the real three-dimensional object obtaining a three-dimensional virtual image corresponding to the three-dimensional surface of the starting object. The three-dimensional virtual image comprises, therefore, a plurality of points, or pixels having determined spatial coordinates (x,y,z) and corresponding to the spatial coordinates of the three-dimensional object.

Preferably, the cutting device is a pantograph.

Alternatively, the cutting device can be a machine for electro-erosion, or a photoengraving device.

In an exemplary embodiment, the cutting device is a laser pantograph.

In an exemplary embodiment of the invention, the mould is made by a 3D printing.

In particular the body of stiff material, or semirigid, may have substantially cylindrical shape, or may a substantially planar development, for example a sheet.

Advantageously, the stiff-material, or semirigid, is selected from the group consisting of:
a metal;
a metal alloy;
a plastic material;
a mixture of plastic materials.

Preferably, in the case of a plastic material or of a mixture of plastic materials the stiff material, or semirigid material, is a material having a hardness higher than 85 Shore.

Preferably, the printing step is made by a printing apparatus.

In particular the object can be a model reproducing an original artwork.

In an exemplary embodiment of the invention before the printing step a step is provided of arranging a sheet, or support, as base at the surface of the layer of thermoplastic material opposite to the modelled surface, i.e. opposite to the printing apparatus, said step of arranging configured to cause the thicknesses made on said layer to coincide with those of the image to print, i.e. the image present on said surface of said original artwork, on said decorative surface.

The possible application of the thermoplastic material on the support can occur:
before the moulding step by means of application by spraying, spreading, and similar systems; or
during the moulding step by the arrangement of the thermoplastic material between the mould and the support.

Furthermore, to assist the disengagement of the thermoplastic material from the mould, between the mould and the thermoplastic a material can be interposed selected among:
a detachment material selected from the group consisting of: a wax, a silicone rubber-based material or other a suitable material;
a film of plastic material, preferably of polyester having a melting temperature higher than the softening temperature of said thermoplastic material.

Furthermore, to assist the disengagement of the thermoplastic material from the mould, between the mould and the thermoplastic material a film of a non-stick material can be interposed selected from the group consisting of: a wax, a silicone rubber-based material, a polyester.

For example, the film of non-stick material may have a melting temperature higher than the softening temperature of said thermoplastic material.

In particular the film of non-stick material may have a thickness of 15-20 micron.

### BRIEF DESCRIPTION OF THE DRAWINGS

The invention will be now shown with the following description of an exemplary embodiment thereof, exemplifying but not limitative, with reference to the attached drawings wherein:

FIG. 1 diagrammatically shows a top plan view of an exemplary object of which an exact copy the can be made through the method according to the present invention;

FIG. 2 shows the original artwork of FIG. 1 in a cross section according to arrows II-II;

FIG. 3 diagrammatically shows an enlarged view of a portion of the cross-section of FIG. 2 for highlighting some morphological features of the surface of the original artwork;

FIGS. 4 to 16 diagrammatically show cross sectional views of a possible succession of steps provided by the method according to the invention for duplicating in series an object, in particular FIGS. 9A and 10 show some alternative embodiments for carrying out the step of diffusion of the setting material on the three-dimensional surface of the mould;

FIGS. 17 and 18 diagrammatically show a succession of steps through which it is possible to provide a model of an original artwork that can be used for duplicating an object in series, for example using a 3D scanner in a step of scanning the original artwork;

FIGS. 18A and 18B diagrammatically show two possible exemplary embodiments of a mould obtained in a cutting step provided by an exemplary implementation of the method, according to the invention;

FIG. 19 diagrammatically shows a procedure provided by the method according to the invention to provide a mould starting from a real object;

FIG. 20 shows in detail an enlarged view of a portion of the mould obtained through the procedure of FIG. 19;

FIGS. 21A to the 21C diagrammatically show side views of a possible succession of steps provided by the method, according to the invention, for making a cast having a three-dimensional surface reproducing the three-dimensional surface of the real object, or virtual, using the mould of FIG. 18A, or 18B, reproducing in negative the three-dimensional surface of the object;

FIGS. 22A to the 22C diagrammatically show side views of a possible succession of steps alternative to that shown in FIGS. 21A to the 21C to provide a cast having a three-dimensional surface;

FIG. 23 is a possible exemplary embodiment of the pressing steps and heating FIGS. 21C and 22C;

FIG. 24B shows a side view of a cast obtained through the steps of FIGS. 21C, 22C and 23;

FIG. 24B shows an enlarged view of the three-dimensional surface of the cast of FIG. 24A in order to highlight some characteristics;

FIG. 25 shows a side view of a reproduction obtained subjecting to a printing step the cast of FIG. 10A;

FIG. 26 shows an enlarged view of the three-dimensional surface of the reproduction of FIG. 11 in order to highlight some characteristics;

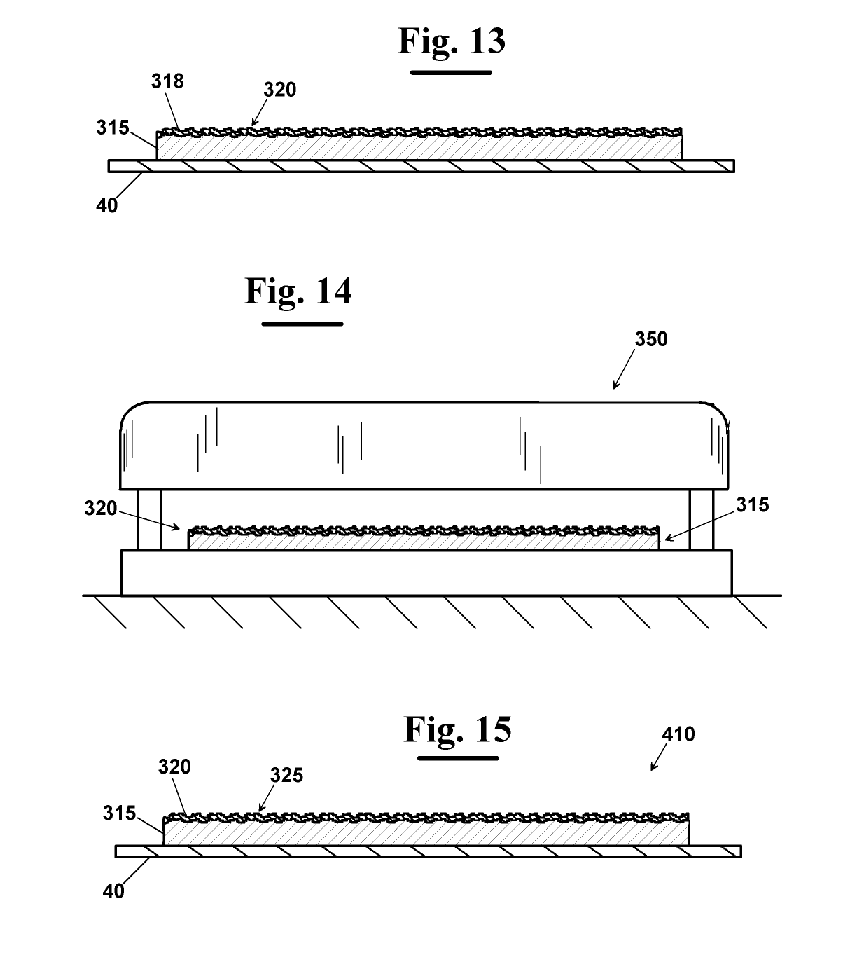

FIG. 13 shows diagrammatically a possible printing machine that can be used for executing the printing process of the invention;

FIG. 14 diagrammatically shows an optional patination step of the modeled layer before printing;

FIG. 15 diagrammatically shows a printing step alternative to that of FIG. 13, because carried out after the patination step of FIG. 14.

### DETAILED DESCRIPTION OF SOME EXEMPLARY EMBODIMENTS

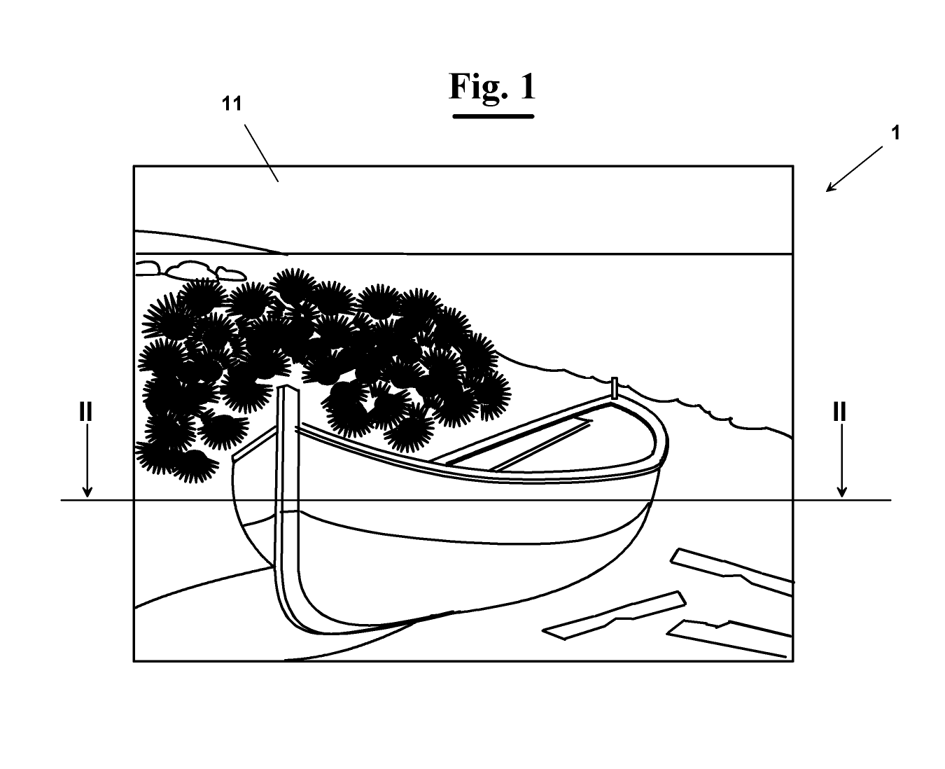

In FIG. 1, a top plan view is shown of an example of an object 1, for example a painting artwork, a photography, or other article having a decorative three-dimensional surface 11 that can be reproduced in series through the process, according to the present invention.

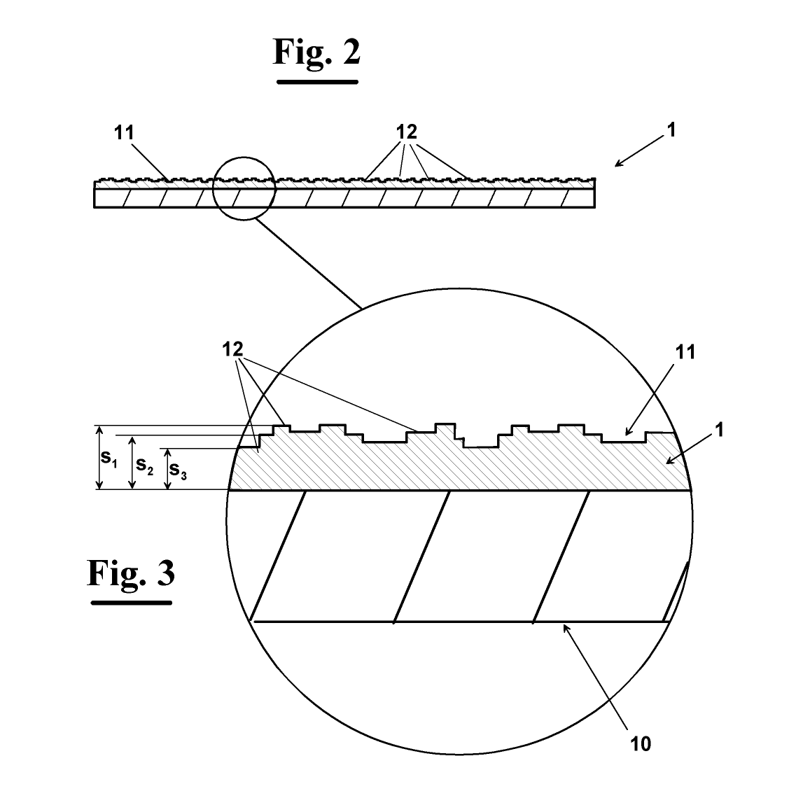

As shown in detail in the cross sectional view of FIG. 2, and in particular in the enlarged view of FIG. 3, the three-dimensional decorative surface 11 of object 1 is normally irregular and has a plurality of ridges and of depressions 12, which can be present in the case of a painting, or a photography with parts in relief, by the type of brush stroke, and/or by the number of layers, and/or by the amount of colour used by the artist, or by the printing machine used, or through particular artistic processes that form protrusions on the decorative surface 11. Each ridge, or depression, 12 has, in particular, a specific thickness s, or depth, i.e. a predetermined distance from a base surface 10, or by another reference plane. For example, the thickness, or the height of the ridges, or the depth of the depressions, 12 can be between 50 μm and 50 mm, sometimes between 0.05 mm and 40 mm, or even between 0.1 mm and 30 mm. Normally, the decorative three-dimensional surface 11 consists of a plurality of ridges 12 of thicknesses, each having a height, and a plurality of depressions 13 each having a depth.

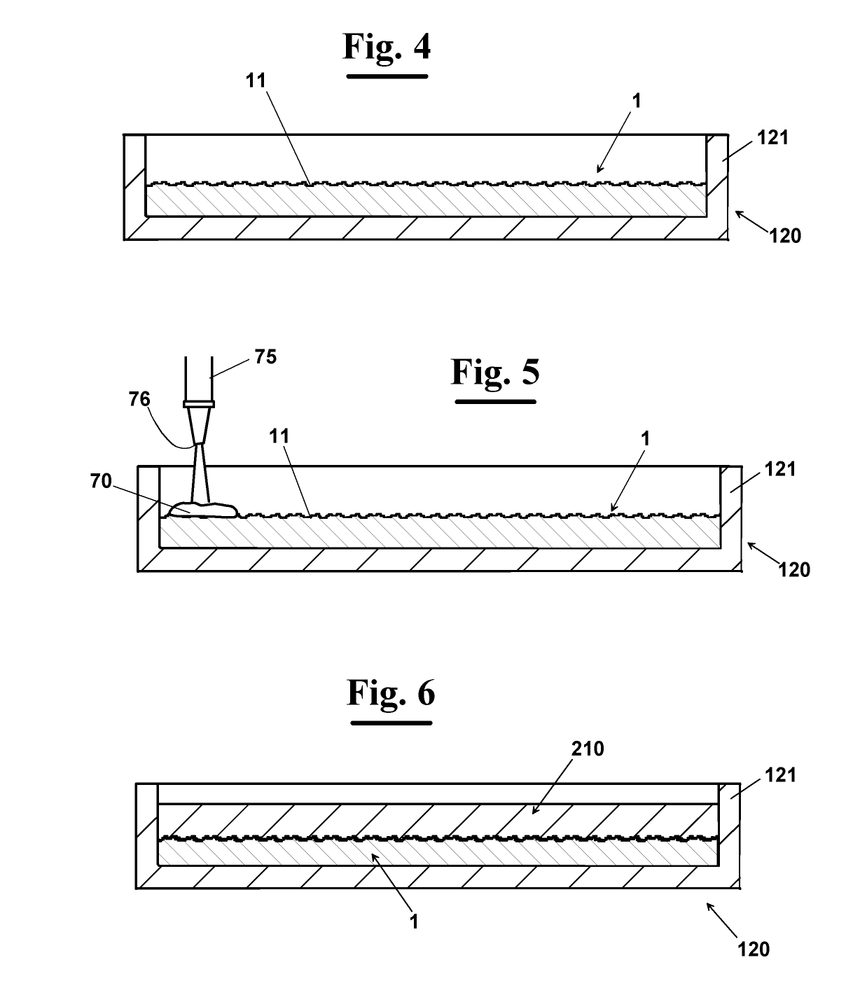

The method provides putting object 1 in a hollow container body 120 having a containing side 121 that, in use, extends in height beyond object 1 (FIG. 4). It is provided, then a step of distributing on object 1 a setting material 70, covering the whole three-dimensional surface 11 of object 1. As diagrammatically shown in FIG. 5, the setting material 70 can be, for example, distributed on surface 11 of object 1 by dispenser 75 having a nozzle 76.

Once reached a predetermined hardening rate of the setting material 70 a mould is obtained 210. The setting material 70 is preferably a material having a coefficient of shrinkage substantially zero during the steps of hardening, such as silicone rubber, gypsum, in particular a material based on gypsum, an epoxy resin, a polyurethane resin, a silicone rubber, or a mixture thereof, or a mixture of two of them.

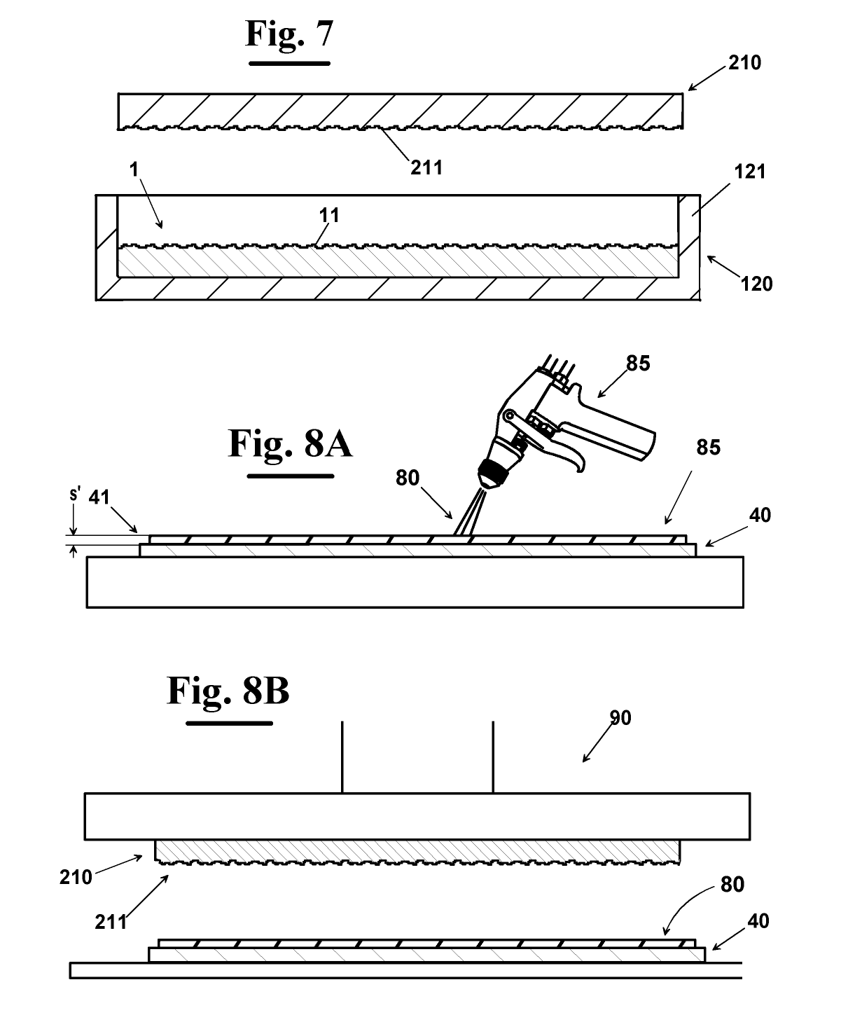

Once hardened, mould 210, at the face oriented towards object 1, has a surface 211 reproducing in negative the three-dimensional surface 11 of object 1 (FIGS. 6 and 7).

According to the invention, a step is then provided of arranging a support, or base sheet, 40. More in detail, at a first face 41 of support 40 a thermoplastic material 80 is applied, obtaining a layer 85 of thermoplastic material 80 having predetermined height, for example set between 50 μm and 20 mm (FIG. 8A).

As diagrammatically shown in FIG. 8B, a step follows of overlapping a mould 210 on support 40, provided as described above, of the layer of thermoplastic material 80, obtaining a system 250 comprising the combination of support 40 and of mould 210, where the first face 41 of support 40 is arranged in contact with three-dimensional surface 211 of mould 210 (FIG. 8B).

To system 250, which is comprised of mould 210 and of support 40, a predetermined amount of heat is then transmitted. This is made by substantially melting thermoplastic material 80 and, accordingly, distributing it on the three-dimensional surface of mould 210. More in detail, the thermal power supplied permits to pass the softening temperature of thermoplastic material 80 in such a way to cause it to a substantial fusion, i.e. reaching a viscosity very low of the material same. This way, a high fluidity is obtained of thermoplastic material 80, allowing to fill the depressions and interstices of a few mm present on three-dimensional surface 211 of mould 210. This allows to cover in a precise and definite way all the surface 211 and then to ensure an exact reproduction of the starting object both in case of real objects such as artwork, artistic objects and the like, or virtual objects “drawn” by a graphical program.

The heat can be provided to system 250 as a whole, or in a way that heats only one of the components of system 250, in particular only thermoplastic material 80. For example the heat source can be a heating plate, or one, or more lamps 95, or other heating devices.

Preferably, to system 250 also a predetermined pressure is used to assist the penetration of molten thermoplastic material 80 in the depressions of surface 211 of mould 210 and around the ridges present on surface 211.

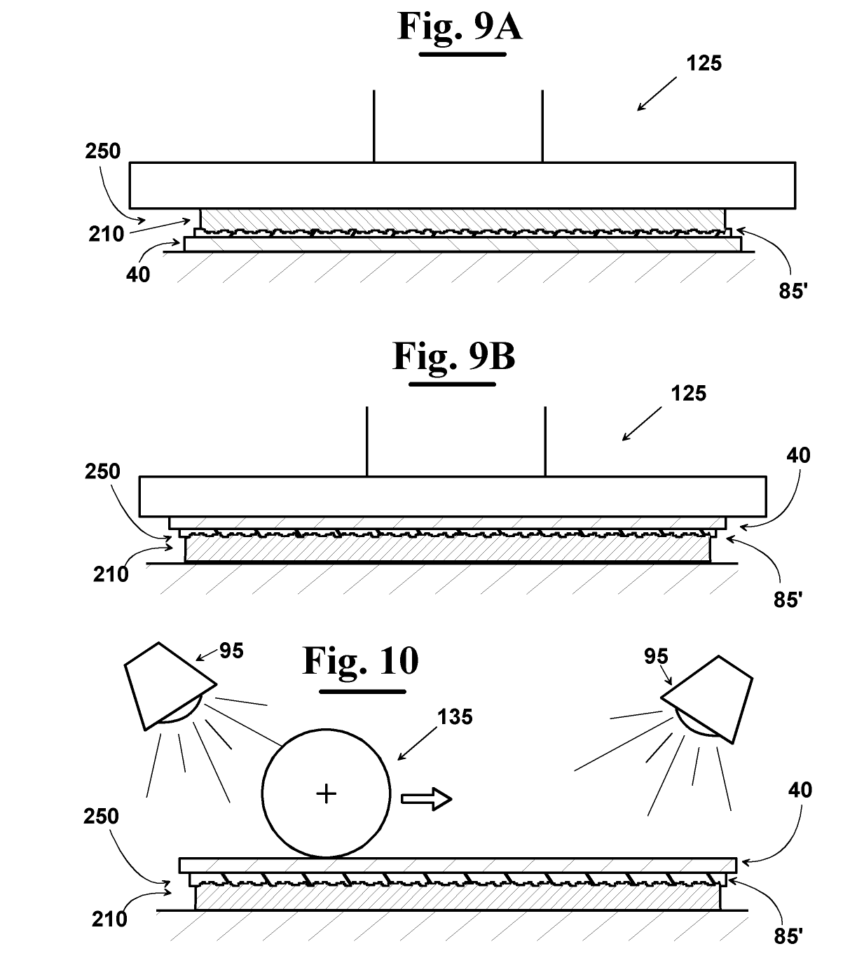

The pressure on system 250 can be applied by a press 125 (FIG. 9A), or by a roller 135 (FIG. 10), or by means of other similar devices not shown in Fig. Advantageously, in the exemplary embodiment of FIG. 9B, the press produces a pressure from the side of the support 40, whereas in the exemplary embodiment of FIG. 9A the pressure is produced at the side of mould 210.

Then, the system 250 is cooled, and, in particular layer 85′ of thermoplastic material 80, up to setting. This way, a cast 315 is obtained having a surface 316 which is an exact copy of the three-dimensional surface 11 of object 1.

Mould 210 is preferably made of a non-stick material, such as silicone rubber, to assist the separation of the system 250 and to ensure that thermoplastic material 80, once cooled, is constrained to sheet 40. This ensures also that the surface of the cast reproduces in am exact way the surface 211 of mould 210. It is in any case also provided that mould 210 is made of a non-adhesive material. In this case, a step is preferably provided of application of a non-stick material, for example a silicone rubber-based material.

As diagrammatically shown in FIG. 8A, the distribution of the thermoplastic material can be carried out by spraying, for example by a dispenser 85, but other solutions are also provided for example distributing thermoplastic material 80 by means of lamination, or by a transfer roller, or in any case similar systems.

Preferably, the distribution of thermoplastic material 80 on support 40 provides an application of a thin layer of thermoplastic material, for example with thickness set between 100 mm and 400 mm. Therefore, it is possible to avoid arranging support 40 in a container body. However, it is not excluded that, for determined applications, or for the type of thermoplastic material, it is necessary to use high amount of thermoplastic material. In this case, support 40 is advantageously housed within a container body. Thermoplastic material 80 can be, for example a thermoplastic resin, or a mixture of thermoplastic resins. Such products can provide also a predetermined adhesive action that assists further the separation of the system 250. The thermoplastic material has preferably a melting temperature T* less than 180-200° C. This way, it is preserved the soundness of the material of mould 210 during heating when causing the substantial melting of thermoplastic material 80 as described above. Therefore mould 210 is not damaged or not “affected” by the final duplication.

The base sheet, or support, 40, can be of a stiff material, such as wood, metal, or plastic material. Alternatively, the base sheet 40 can be made of a flexible material, for example canvas, paper, non woven fabric, or the like. Once reached a predetermined hardening rate of layer 85′, i.e. the layer of material spread on the depressions of three-dimensional surface 211 of mould 210, a cast 315 is obtained having a decorative surface 316 that is an exact reproduction of the three-dimensional surface 11 of object 1. More in detail, as shown in FIG. 12, the decorative surface 316 of the cast 315 has a plurality of ridges 312 corresponding to the thickness s of the ridges 12 of the three-dimensional surface 11 of object 1. In particular the ridges 312 can have the same thickness s′ as the thickness s of the ridges 12 of surface 11 of object 1, or they can be in a predetermined ratio with respect to each other for example 1 to 2, 1 to 3, etc.

The decorative surface 316 can be, then, subject to a printing step, in order to obtain, then, a printed decorative surface 317 by ink, or colour, applied in determined points of the surface 316.

Alternatively, as diagrammatically shown in FIGS. 13 to 15, a patination step of surface 316 can be provided obtaining a decorative patinated surface 318. The patination can provide, for example, an application of a thin layer 320, or film, or a resin coating on the decorative surface 316, in order to optimize the absorption of the colour, in particular of the ink, and allows, therefore, to optimize the image quality. The printing step can be made by means of a printing apparatus 350, such as a printer, or a plotter. The printing apparatus 350 can use a printing technique such as printing, or thermoprinting, with sublimation inks, inkjet printing, print with heat transfer inks, print with water based inks, print with UV inks, i.e. ultraviolet inks, offset printing, print with solvent based inks, print with resin based inks, screen printing, laser printing, sublimation printing.

In a possible exemplary embodiment of the present invention, object 1 can be a duplication of an original artwork. In this case, a preliminary step provides making a model of the object.

For example, the preliminary step of making the model can provide a step of three-dimensional scanning of original artwork 1 obtaining a three-dimensional virtual image 101 having a three-dimensional surface corresponding to that of original artwork 1. More in detail, the three-dimensional virtual image 101 comprises a plurality of points, or pixels having determined spatial coordinates (x,y,z).

The above described step of three-dimensional scanning can be done through the control of pictures, by a special software, or by a 3D scanner 50 of known type. This way a substantially optical detection of the surface to duplicate and a measurement through detection of the electromagnetic signals reflected by the surface are carried out. The 3D scanner provides usually a light source, for example a light laser source, or a structured light source.

In the case of a 3D laser scanner a three-dimensional image is obtained through a triangulation which provides the projection of a point, or of a line, of laser light 60 on surface 11 and a sensor is provided for example a sensor of CCD type, or a sensor of CMOS type, arranged in a certain position to measure the distance from surface 11. Once swept all surface 11, the data obtained are recorded and used for constructing a matrix of points.

In the case of a structured-light scanner, instead, a matrix, or pattern, of light 60 is projected on surface 11 of original artwork 1, and then detected the deformation of the projection of the matrix according to the three-dimensional shape of scanned surface 11. In this case, it is possible to detect the whole visual field in a single step.

In particular, the virtual image 101 obtained by the step of scanning comprises a plurality of points having determined spatial coordinates (x,y,z) that define the three-dimensional geometry of surface 11 of original artwork 1.

The step of three-dimensional scanning provided by the present invention allows detecting the spatial coordinates (x,y,z) of the points of surface 11 of original artwork 1, where the value of the coordinate z coincides with the thickness of the ridge, or protrusions, 12 of the detected points P.

The set of the detected points P and their coordinates (x,y,z) makes it possible to determine the three-dimensional geometry of surface 11. This way, it is possible to provide a model 110 in gypsum, in particular a material based on gypsum, or other easily formable material. Such step can be carried out by a tool 160 of a machine tool 165, for example a pantograph, starting from a semi-finished product 130 having a worked surface 131 (FIG. 17).

The surface of model 110 comprises a plurality of points P′ each of which has the spatial coordinates (x,y,z) of the three-dimensional virtual image 101 and therefore corresponding to surface 11 of original artwork 1 with high precision. At the end a model 1 is obtained having a surface 11 that is used as above described to duplicate in series original artwork 110.

According to another aspect of the invention, a method for making in series the three-dimensional object 1, provides a step of making a mould that is alternative to that described with reference to FIGS. 1 to 7. In this case, in fact, mould 210′ is obtained by engraving a surface 155 of a body of stiff material, or semirigid, 150 by a cutting device 200. The engraving step of surface 155 of the body of stiff material, or semirigid, 150, which can be of metal, wood, or resin, is made by a cutting device, such as a pantograph 165, whose movements are guided on the basis of a plurality of working data. These can be obtained by making ex-novo the three-dimensional object 1 to duplicate, in particular using a graphic software, in particular a CAD program.

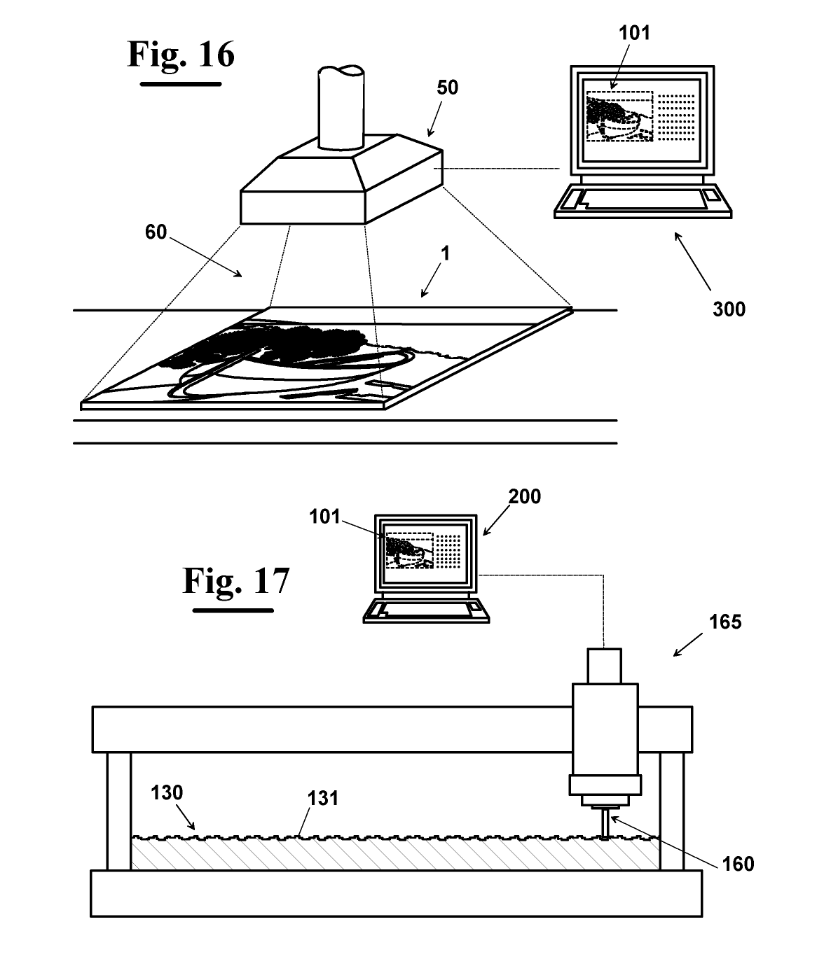

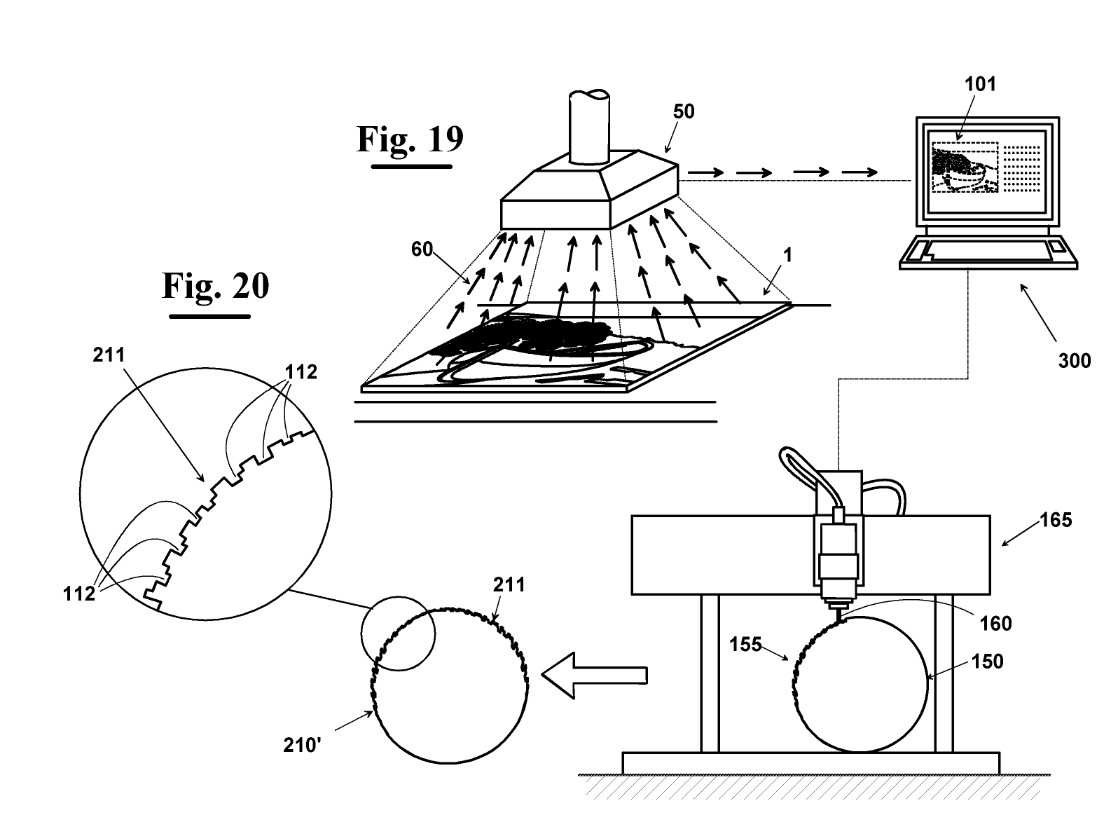

If the three-dimensional object 1 to duplicate is a real object, the above described working data can be obtained by a three-dimensional scanning of object 1, as described above with reference to FIG. 16. More in detail, in this case, the working data used for guiding the cutting device 165 during the step of making mould 210′, are obtained through the control, by a computer 300, of the plurality of points, or pixels, obtained by the 3D scanning (FIGS. 19 and 20).

This way, it is possible to provide a mould 210′ made of another metal, or other stiff material by using, as described above, a cutting device 165, for example a laser pantograph. The surface 211 of mould 210′ comprises a plurality of points P′ each of which has spatial coordinates (x,y,−z) of a corresponding point (x,y,z) of the three-dimensional virtual image 101 and therefore the surface 211 of the mould corresponds “in negative” to surface 11 of original artwork 1 with high precision.

With reference, for example, to FIG. 20, at the end of the step of engraving, the mould 210′ has an imprint surface 211 that reproduces in negative surface 11 of object 1. More in detail, the imprint surface 211 of the mould 100 comprises a plurality of depressions 112 with depth equal to the thicknesses of corresponding ridges 12 of the object surface 11. Similarly, where surface 11 of object 1 has depressions, mould 210′ presents corresponding ridges.

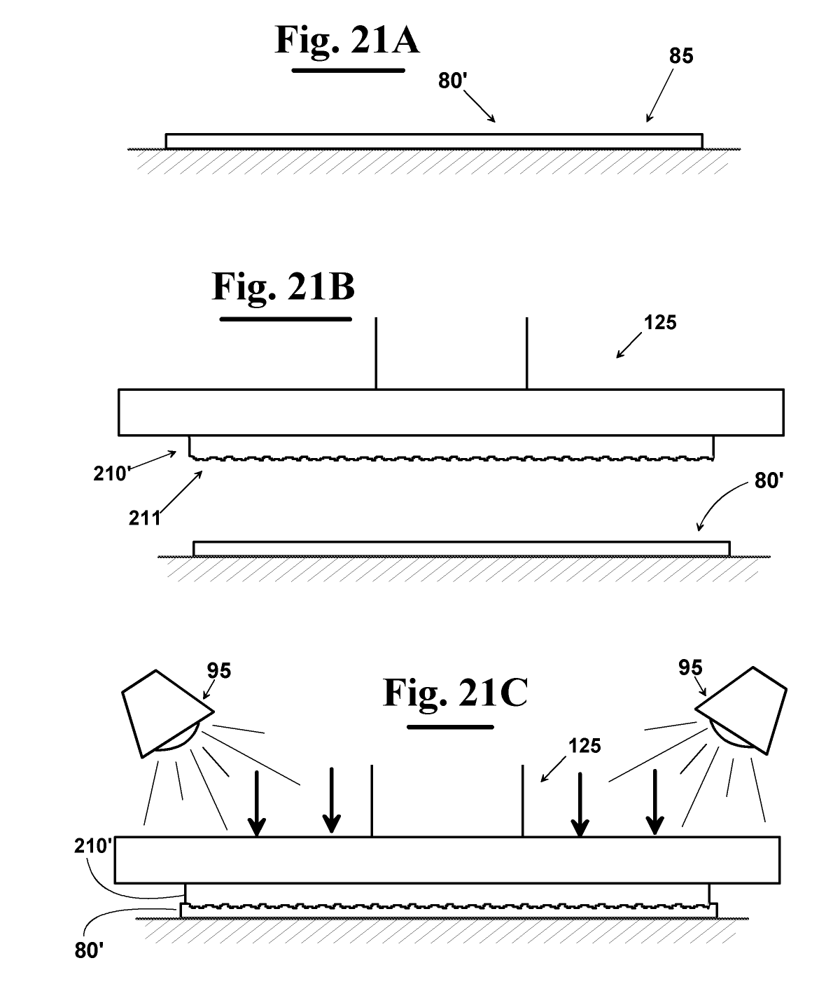

With reference to FIGS. 21A to the 21C, mould 210′ is then used in a moulding step in which the imprint surface 211 is put in contact with a surface of a layer of thermoplastic material 80′ obtaining a modeled layer. More in detail, during the moulding step, mould 100 produces a predetermined pressure on the layer of thermoplastic material 80′. During the moulding the application of heat is also provided. More in detail, thermal power P is supplied during the moulding step reaching the softening threshold T* of the thermoplastic material 80′, in such a way to cause a softening of thermoplastic material 80′ that, then, penetrates in the depressions and in the interstices of a few mm present on three-dimensional surface 211 of mould 210′. This allows to cover in a defined and precise way all the surface 211 of mould 210′ and, accordingly, to ensure an exact reproduction of object 1 both when it is a real object and when it is a virtual object, i.e. computer designed. The heat can be provided directly to layer 80′ of thermoplastic material, or to mould 210′, or even to the system consisting of mould 210′ and layer 80′ of thermoplastic material. The heat source can be a heating plate, or at least one lamp 95, or other similar devices.

As described above, to the system formed by mould 100-layer of thermoplastic material 80′, also a predetermined pressure is used to assist the penetration of the thermoplastic material in the depressions of surface 211 of mould 210′.

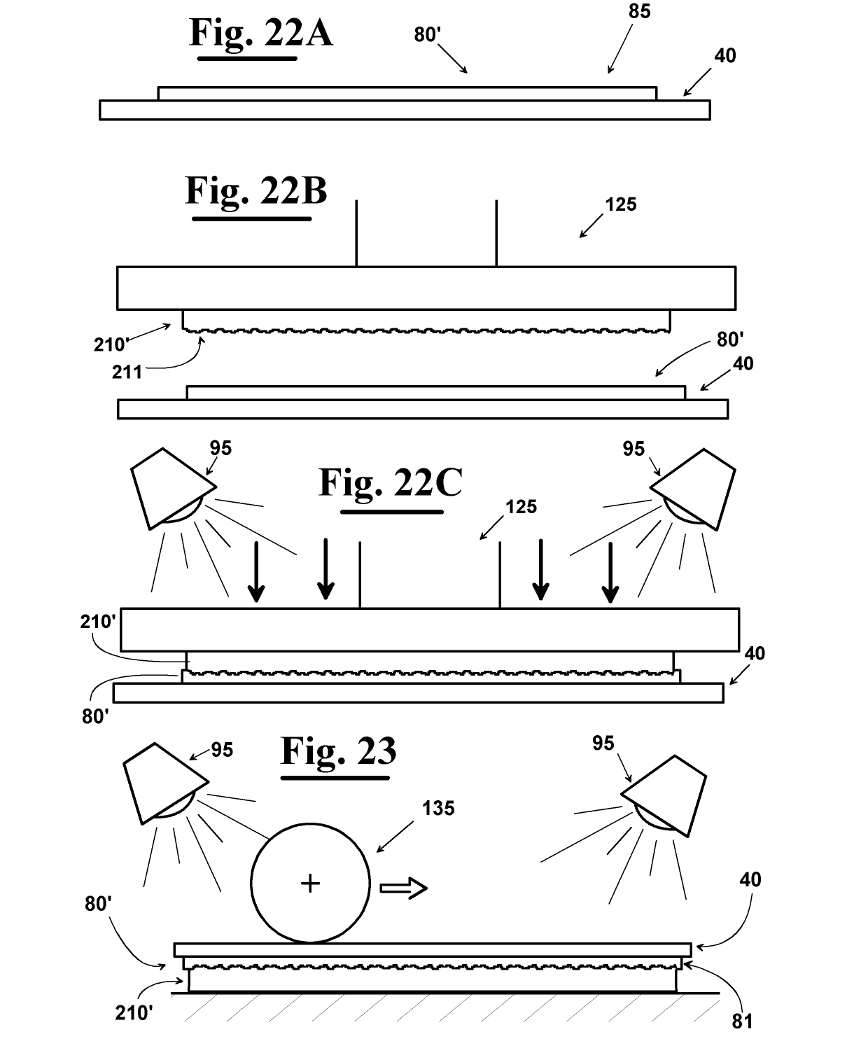

As described above with reference to FIGS. 8A to 8C, before, or at the same time of, the moulding step, a step of application of a base sheet, or support, 40 can also be provided, which is applied at the side of the layer of thermoplastic material opposite to the side from which mould 210′ produces its own action. More in detail, the support 40, which has substantially function of support for the layer of thermoplastic material 80′, can be made of a material selected from the group consisting of: wood, canvas, non woven fabric, metal material, plastic material, a stiff material, a flexible material, paper, or cardboard (FIGS. 22A-22C).

During the moulding step, the above described pressure can be applied at one side of mould 210′, for example by a press 125, as diagrammatically shown in FIGS. 7C and 8C, but it is not excluded that once mould 210′ contacts the surface of layer 80′ of thermoplastic material, the pressure is applied at the side of layer 80′, as diagrammatically shown in FIG. 23. In this case a press, or a roll 135, or other similar device acting opposite to mould 210′ can be provided.

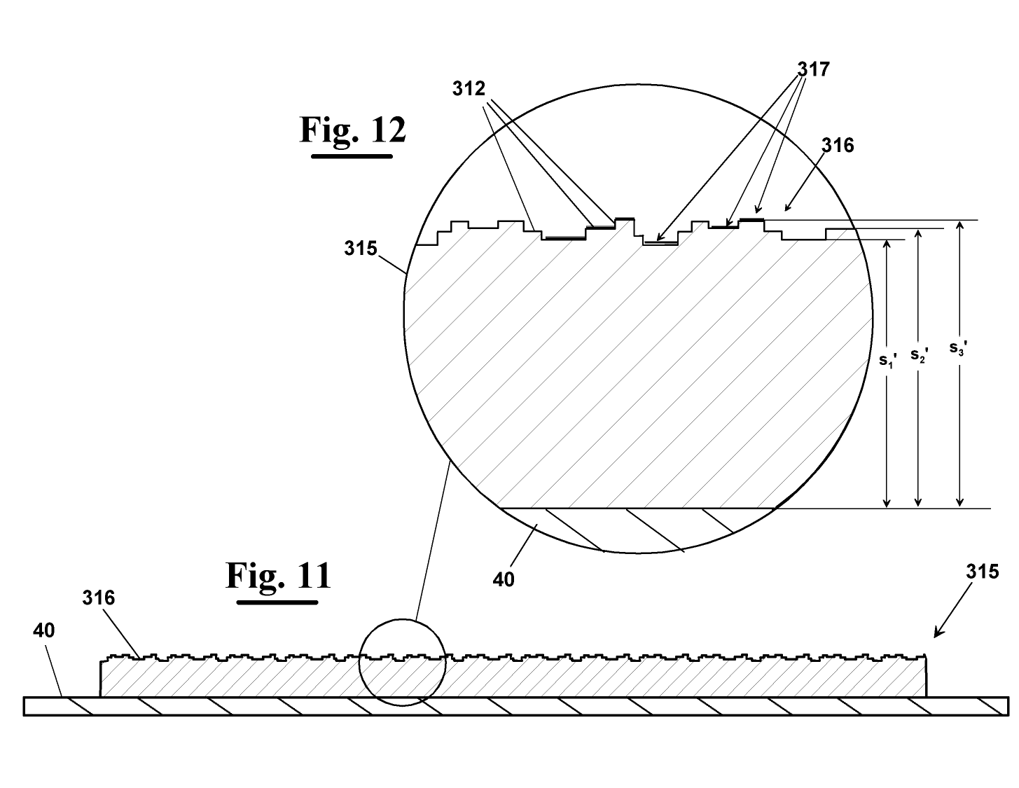

At the end of the moulding step, a cooling of the modeled layer 80′ of the thermoplastic material can be provided up to hardening. At the end of the moulding the modeled layer 315 of the thermoplastic material that is obtained has a modeled surface 316 that reproduces surface 11 of object 1 (see what above described with reference to FIGS. 11 and 12).

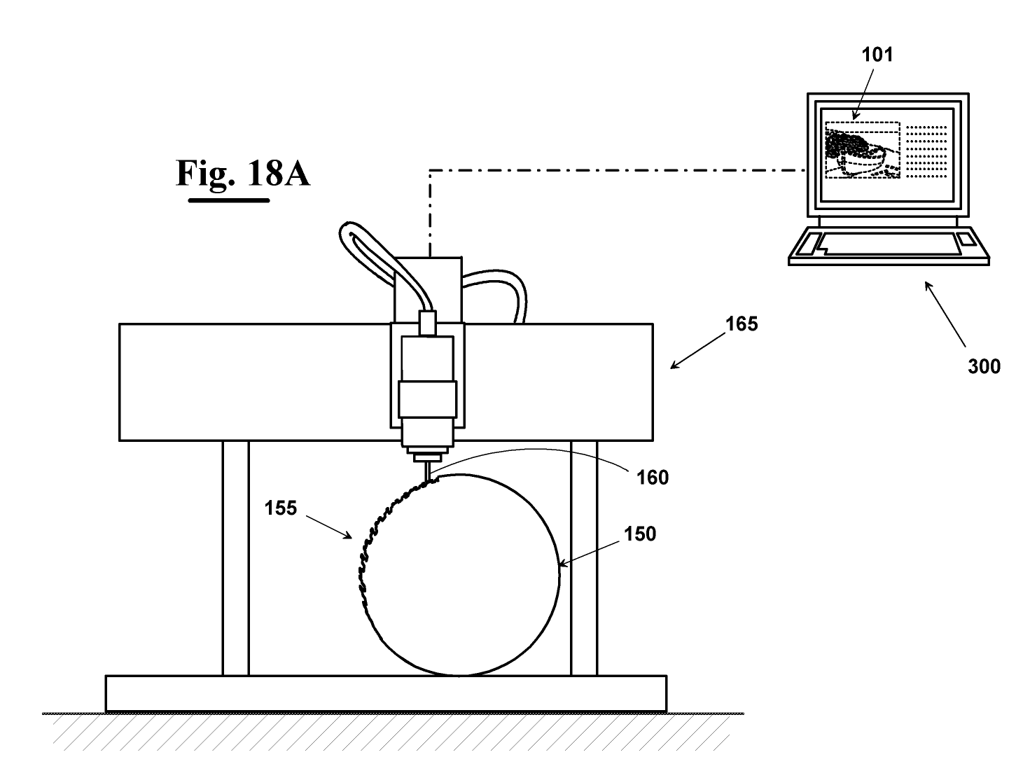

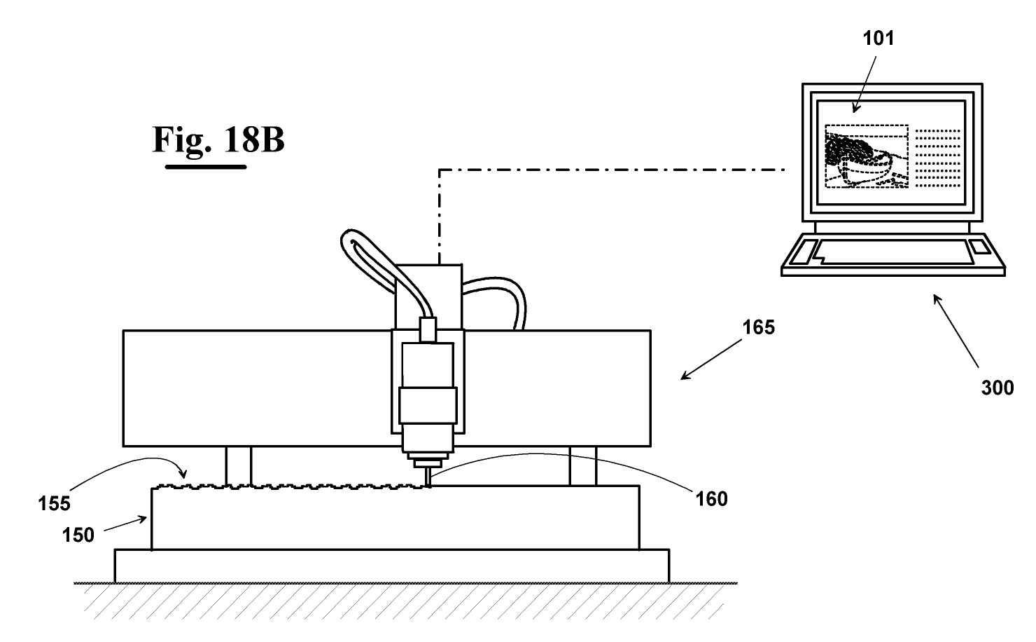

As shown in FIG. 18A the body of stiff material, or semirigid, 150 that is cut to obtain mould 210′ may have substantially cylindrical shape, or have a substantially planar development as in the example of FIG. 18B.

The thermoplastic material 80′ can be, for example a thermoplastic resin, or a mixture of thermoplastic resins. Furthermore, it is possible to add at least one organic, or inorganic charge, such that the thermoplastic material can attain desired features. For example, to the thermoplastic material a predetermined percentage by weight, for example 2-3%, of polymers, and preferably of colouring substances can be added. This is done for increasing, in particular the stiffness of the thermoplastic material 80′, in order to avoid the use of the base support, or sheet, 40.

Once achieved the predetermined hardening rate of the thermoplastic material, a semi-finished product 315 is obtained having a modeled surface 316 that is an exact copy of the three-dimensional surface 11 of object 1, as described in detail for previous case with reference to FIGS. 11 and 12.

Still with reference to FIGS. 12 and 13, the modeled surface 316 is then subject to a register printing step, in order to obtain a printed modeled surface to which a predetermined amount of ink, or colour, 317 is applied at predetermined points of surface 316 above described.

Also in this case, before to print the modeled layer 90, the surface 315 may undergo to a patination step obtaining a patinated decorative surface 318.

The foregoing description of specific exemplary embodiments will so fully reveal the invention according to the conceptual point of view, so that others, by applying current knowledge, will be able to modify and/or adapt in various applications the specific exemplary embodiments without further research and without parting from the invention, and, accordingly, it is meant that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not of limitation.

1. A process for duplicating in series an object having a decorative three-dimensional surface comprising a plurality of ridges, or protrusions, each ridge of said plurality having a predetermined thickness, or height (s), said process comprising the steps of:
introducing said object in a hollow container body;
distributing on said object a setting material, said setting material covering said decorative three-dimensional surface of said object;
hardening said setting material obtaining a mould said mould providing at the face oriented towards said object a three-dimensional surface reproducing in negative said three-dimensional surface of said object;
arranging a substantially planar support;
distributing a predetermined amount of a thermoplastic material on a first face of said support, obtaining a layer of said thermoplastic material having a predetermined height;
arranging said support and said mould overlapped to one another to obtain a system comprising said support and said mould, wherein said first face of said support is arranged in contact with said three-dimensional surface of said mould;
applying heat and pressure to said system in such a way to cause a substantial melting of said thermoplastic material and its distribution on the three-dimensional surface of the mould obtaining a corresponding substantially molten layer of said thermoplastic material;
cooling said corresponding layer of the thermoplastic material in such a way to cause it to harden obtaining a cast of said object, said cast having a decorative surface that reproduces said surface of said mould and then of said surface of said object, said decorative surface of said cast comprising a plurality of ridges with thicknesses corresponding to those of said ridges of said object;
printing said decorative surface obtaining a printed decorative surface and then a duplication of said object.

2. The process according to claim 1, wherein said step of distributing said thermoplastic material is made by spraying, or lamination, or by a transfer roller, or using other devices that apply the second material directly on the support.

3. The process according to claim 1, wherein said layer of thermoplastic material obtained at the end of said step of distributing said thermoplastic material on said support has a thickness set between 50 μm and 20 mm.

4. The process according to claim 1, wherein said thermoplastic material is selected from the group consisting of:
a thermoplastic resin;
a mixture of thermoplastic resins.

5. The process according to claim 1, wherein said thermoplastic material has a melting temperature T* less than 200° C.

6. The process according to claim 1, wherein said object is a model reproducing an original artwork, said original artwork having a three-dimensional surface comprising a plurality of ridges, or protrusions, each ridge of said plurality having a predetermined thickness, or height, and also a step is provided of making said object comprising:
three-dimensional scanning of said original artwork obtaining a three-dimensional virtual image corresponding to said three-dimensional surface of said original artwork, said three-dimensional virtual image comprising a plurality of points, or pixels having determined spatial coordinates (x,y,z);
producing, on the basis of said spatial coordinates (x,y,z), of said model having a surface that reproduces said three-dimensional virtual image, said model being made of an easily formable material.

7. The process according to claim 1, wherein said printing step is made by a printing apparatus.

8. The process according to claim 6, wherein said printing apparatus uses one of the following printing techniques:
printing, or thermoprinting, with sublimation inks;
inkjet printing;
printing with heat transfer inks;
printing with water based inks;
printing with UV inks, i.e. ultraviolet inks;
offset printing;
printing with solvent based inks;
printing with resin based inks;
dye sublimation printing;
screen printing;
laser printing;
or a combination thereof.

9. The process according to claim 1, wherein before said printing step a step is provided of patination of said decorative surface, said patination adapted to optimize the rate of absorption of colour, in particular ink, from said decorative surface, said patination step providing a step of application of a thin layer, or film, of resin on said decorative surface in a way suitable to optimize the colour absorption, in particular of ink, and to improve then the printing quality.

10. The process according to claim 1, wherein, comprising the further steps of:
definition on said three-dimensional surface of at least one reference point;
locating in a way referred between said printing machine and said, or each, reference point, in a way suitable to have the reliability of applying a predetermined amount of a specific colour at a specific area of the three-dimensional surface.

11. The process according to claim 1, wherein said setting material is a setting material having a coefficient of shrinkage during the step of hardening substantially zero, said setting material being selected from the group consisting of:
gypsum, in particular a material based on gypsum;
silicone;
an epoxy resin;
a polyurethane resin;
a silicone rubber;
a photopolymer;
or a combination thereof.

12. The process according to claim 1, wherein said planar support is made of a material selected from the group consisting of:
wood;
canvas;
non woven fabric;
metal material;
plastic material;
a stiff material;
a flexible material;
paper, or cardboard.

13. The process according to claim 1, wherein said step of distributing said thermoplastic material on said sheet is made by spraying, or lamination, or by a transfer roller.

14. The process according to claim 1, wherein said setting material is a metal material, in particular a metal material in the molten state.

15. A process for making in series an object having a decorative three-dimensional surface comprising a plurality of ridges, or protrusions, each ridge of said plurality having a predetermined thickness, or height (s), said process comprising the steps of:
making a mould of stiff material, or semirigid, and having a surface that reproduces in negative said surface of said object, said surface of said mould comprising a plurality of depressions with depth corresponding to the thicknesses of said ridges of said object;
moulding, by said mould, a surface of a layer of thermoplastic material obtaining a modeled layer, said moulding step providing a pressing and a heating of said layer of thermoplastic material;
extracting said modeled layer of the thermoplastic material having a modeled surface that reproduces said surface of said object comprising a plurality of ridges with thicknesses corresponding to those of said ridges of said object;
register printing of said modeled surface obtaining a corresponding decorative surface and then a duplication of said object.
